(19) United States
(12) Patent Application Publication
(10) Pub. No.: US 2013/0074652 A1
(43) Pub. Date: Mar. 28, 2013

(54) Starter Motor Having Clutch with Grooved Roller Elements

(71) Applicants: Joel M. Gray, Fishers, IN (US); Michael E. Kirk, Greenfield, IN (US); Balazs Palfai, Fishers, IN (US); Jason W. Nipper, Anderson, IN (US)

(72) Inventors: Joel M. Gray, Fishers, IN (US); Michael E. Kirk, Greenfield, IN (US); Balazs Palfai, Fishers, IN (US); Jason W. Nipper, Anderson, IN (US)

(73) Assignee: REMY TECHNOLOGIES, LLC, Pendleton, IN (US)

(21) Appl. No.: 13/244,321

(22) Filed: Sep. 24, 2011

(51) Int. Cl. F02N 15/02; F16D 41/066

(52) U.S. Cl. 74/7 C; 192/42

(57) ABSTRACT

A clutch includes an outer clutch member, an inner clutch member, and a plurality of roller members. The outer clutch member defines an opening, and the inner clutch member is at least partially positioned within the opening. The inner clutch member includes a clutch surface. The plurality of roller members is at least partially positioned within the opening between the clutch surface and the outer clutch member. The roller members define a plurality of roller surfaces separated by at least one annular groove. Each of the roller members is displaceable within the opening to position the roller surfaces into engagement with the clutch surface to lock the inner clutch member into synchronous movement with the outer clutch member in response to movement of the inner clutch member in a rotational direction.

### FIELD

This disclosure relates to the field of starter motor assemblies for starting an engine, and particularly to a clutch portion of the starter motor assembly.

### BACKGROUND

Starter motor assemblies are typically used to assist in starting engines, including the engines in most passenger vehicles. The conventional starter motor assembly broadly includes an electric motor coupled to a drive mechanism. The electric motor is energized by a battery upon closing of an ignition switch. The drive mechanism transmits torque generated by the electric motor to a flywheel of the engine, thereby rotating the flywheel and causing the engine to start. After the engine is started the ignition switch is opened and the electric motor becomes deenergized.

Typically, the starter motor assembly includes a clutch in operational communication with the electric motor and the drive mechanism. The clutch operates to couple rotation of the electric motor to the drive mechanism during engine start up and further operates to decouple the electric motor from the drive mechanism when the engine begins generating its own rotational force. In this way the clutch prevents damage to the electric motor and other parts of the starter motor assembly.

One conventional clutch used in starter motor assemblies is a roller clutch, which includes an inner ring positioned within an outer ring. The inner ring may be connected to the electric motor and the outer ring may be connected to the drive mechanism, or vice versa. The clutch includes roller elements positioned in pockets formed within the outer ring. Biasing members bias the roller elements against a cam surface of the outer ring and against the inner ring.

The roller elements of the clutch function to lock and unlock the inner ring from the outer ring. In particular, the roller elements lock the inner ring into synchronous rotation with the outer ring in response to rotational movement of the inner ring relative to the outer ring in a first rotational direction. Likewise, in an overrun phase, the roller elements unlock the inner ring from the outer ring in response to rotational movement of the inner ring relative to the outer ring in an opposite rotational direction. Accordingly, the clutch may be used to couple rotation of the electric motor to the drive mechanism and the flywheel during engine start up (i.e. the clutch is in the locked configuration), and then to decouple the electric motor from the drive mechanism and the flywheel when the engine starts (i.e. the clutch is in the unlocked configuration during the overrun phase).

It is advantageous with roller clutches to increase the pressure provided by the roller elements on the inner ring, particularly at low operating temperatures. Methods for increasing the roller pressure include increasing the force provided by the biasing members and/or changing the cam angle of the cam surfaces formed in the outer ring. These changes, however, cause the overrun torque of the clutch to increase, thereby increasing the amount of engine torque transmitted to the electric motor during the overrun phase. Also, changing the cam angle results in an increased manufacturing cost when forming new forging tools and gauges.

Therefore, it is advantageous to provide a starter motor clutch having roller elements, which apply a pressure to the inner ring and the outer ring that functions to lock and unlock the rings at all operating temperatures of the starter motor assembly and that can be provided without modifying the tools and equipment used to the manufacture the other portions and components of the clutch.

### SUMMARY

In accordance with one embodiment of the disclosure, a clutch includes an outer clutch member, an inner clutch member, and a plurality of roller members. The outer clutch member defines an opening, and the inner clutch member is at least partially positioned within the opening. The inner clutch member includes a clutch surface. The plurality of roller members is at least partially positioned within the opening between the clutch surface and the outer clutch member. Each of the roller members define a plurality of roller surfaces separated by at least one annular groove, and each of the roller members is displaceable within the opening to position the plurality of roller surfaces into engagement with the clutch surface to lock the inner clutch member into synchronous movement with the outer clutch member in response to movement of the inner clutch member in a rotational direction.

In one embodiment, a clutch includes a shell, a clutch collar, a plurality of roller members, and a plurality of biasing members. The shell defines a shell opening and includes a plurality of pocket walls. Each pocket wall defines a pocket in fluid communication with the shell opening. The clutch collar is at least partially positioned within the shell opening and includes a clutch surface. Each roller member defines a plurality of roller surfaces separated by at least one annular groove. Additionally, each roller member is positioned within one of the pockets. Each biasing member (i) is positioned within one of the pockets and (ii) is configured to urge the roller surfaces of one of the roller members against the clutch surface and one of the pocket walls.

In at least one embodiment, a starter motor for an engine includes an armature, a solenoid, a pinion, a clutch, a shell, a clutch collar, and a plurality of rollers. The pinion is rotatable by the armature and movable by the solenoid into engagement with a corresponding portion of the engine. The clutch is in operational communication with the pinion and the armature. The clutch includes a shell defining a shell opening and a clutch collar. The clutch collar is at least partially positioned within the shell opening and includes a clutch surface and a plurality of rollers. The plurality of rollers is at least partially positioned within the shell opening between the clutch surface and the shell. Each of the rollers defines a plurality of roller surfaces separated by at least one annular groove, and each of the rollers is displaceable within the shell opening to position at least a portion of the roller surfaces into engagement with the clutch surface to lock the clutch collar into synchronous movement with the shell in response to movement of the clutch collar in a rotational direction relative to the shell.

In another embodiment, a clutch includes a shell, a clutch collar, a plurality of roller members, and a plurality of annular grooves. The shell defines a shell opening and a plurality of pockets in fluid communication with the shell opening. The clutch collar is at least partially positioned within the shell opening and includes a clutch surface. Each roller member defines a roller surface, and each roller member is positioned within one of the pockets. The annular grooves are formed in at least one of the clutch surface of the clutch collar and the roller surfaces of the roller members.

The above described features and advantages, as well as others, will become more readily apparent to those of ordinary skill in the art by reference to the following detailed description and accompanying drawings. While it would be desirable to provide a starter motor that provides one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows a cross sectional view of a starter motor including a clutch with roller members, as described herein;

FIG. 2 is a cross sectional view taken along the line 2-2 of FIG. 1 showing the clutch and a planetary gear arrangement coupled to the clutch;

FIG. 3 is a perspective view, partially cutaway, of a portion of the starter motor of FIG. 1 showing the clutch and the planetary gear arrangement;

FIG. 4 is a perspective view a roller member of the clutch of FIG. 2;

FIG. 5 is an elevational view of the roller member of the clutch of FIG. 2;

FIG. 6 is another elevational view of the roller member of the clutch of FIG. 2;

FIG. 7 is a perspective view, partially cutaway, of a portion of the starter motor of FIG. 1, showing an alternative embodiment of the roller members of the clutch and the clutch surface of the clutch; and

FIG. 8 is an alternative embodiment of the roller member of the clutch of FIG. 2.

### DESCRIPTION

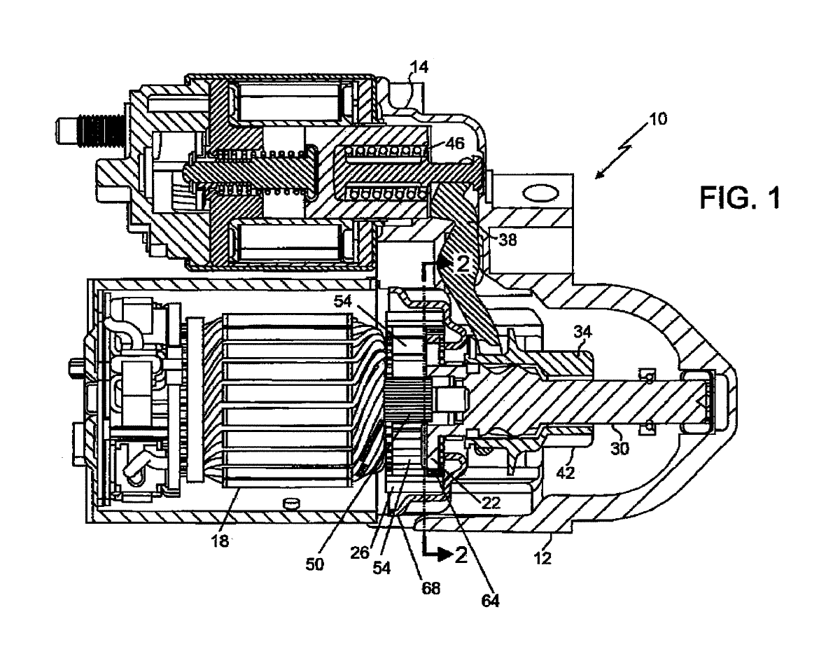

As shown in FIG. 1, a starter motor 10 includes a housing 12, a solenoid 14, an armature 18, a gear system 22, a clutch 26, a shaft 30, and a pinion 34, among other components, The housing 12 is typically connected to an engine (not shown), such as an internal combustion engine of an automobile (also not shown). The armature 18 is at east partially positioned within the housing 12. The armature 18 rotates relative to the housing 12 in response to the armature 18 being supplied with electrical energy. The rotation of the armature 18 is coupled to the pinion 34 through the gear system 22, the clutch 26, and the shaft 30. The armature 18 may be provided as any armature, as may be recognized by those of ordinary skill in the art.

The solenoid 14 is also at least partially positioned within the housing 12. When the solenoid 14 is electrically energized it causes a lever 38 to move the pinion 34 axially along the shaft 30 until gear teeth 42 on the pinion engage with gear teeth (not shown) on a flywheel of the engine. When electrical energy to the solenoid 14 is removed, a return spring 46 within the solenoid 14 returns the pinion 34 and the lever 38 to their original positions, shown in FIG. 1. The solenoid 14 may be provided as any solenoid, as may be recognized by those of ordinary skill in the art.

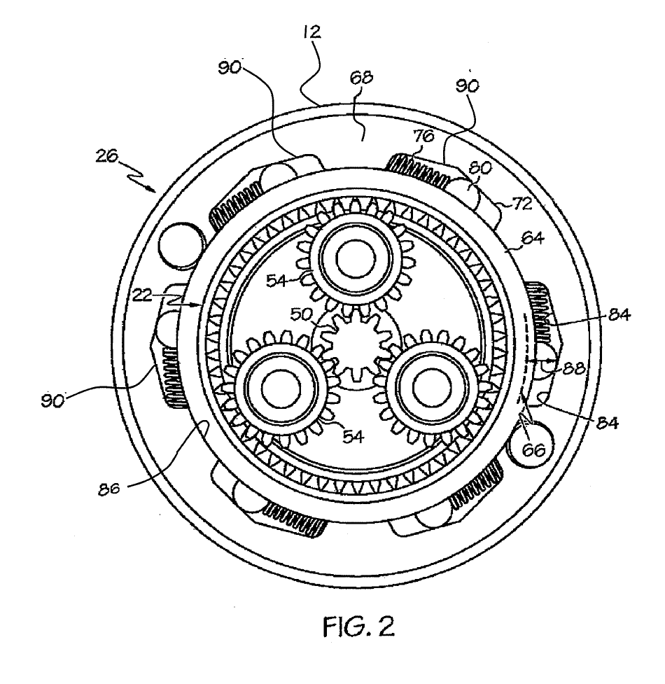

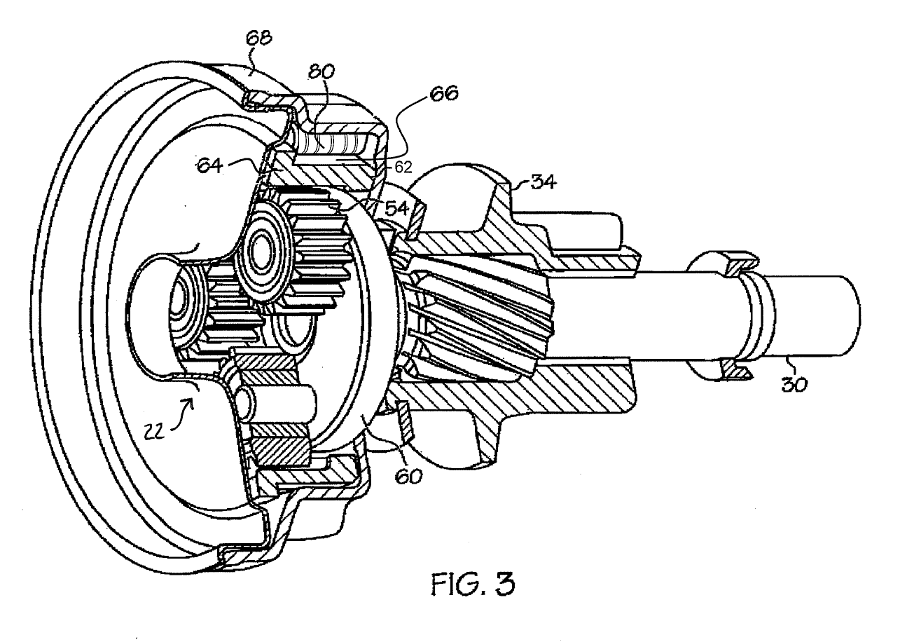

With reference to FIGS. 2 and 3, the gear system 22 is a planetary gear system, which includes a sun gear 50 (not shown in FIG. 3), planet gears 54, and a ring gear 64. In the illustrated embodiment, the sun gear 50 is coupled to the armature 18, such that the armature and the sun gear rotate with the same angular velocity. Additionally, the sun gear 50 is meshingly engaged with the planet gears 54. The three planet gears 54 are attached to a flange 60 (FIG. 3) of the shaft 30, such that rotation of the planet gears 54 around the sun gear 50 results in rotation of the shaft 30. The ring gear 64 is meshingly engaged with the planet gears 54. It is noted that in at least some embodiments, the starter motor 10 does not include the gear system 22 or may include a different type of gear system.

As shown in FIG. 2, the clutch 26 includes an outer clutch member provided as a shell 68, an inner clutch member 62 (which may also be referred to herein as a “collar”), a clutch surface 66, a plurality of springs 76, and a plurality of rollers 80. The shed 68 is fixedly received by the housing 12, defines a shell opening 86, and includes a plurality of pocket walls 90. Each pocket wall 90 defines a pocket 72. The pockets 72 have a generally pentagon shape and include two radially outermost surfaces 84, which intersect to form an obtuse angle. A radial distance 88 between the outermost surfaces 84 of the shell 68 and the cylindrical clutch surface 66 of the collar 62 is greatest where the two outermost surfaces 84 intersect. The radial distance 88 decreases at points further from where the two outermost surfaces 84 intersect. The radial distance 88 is larger than a diameter of the rollers 80 at its greatest point, and the radial distance is smaller than the diameter of the rollers at its smallest point, the significance of which is described below.

One of the springs 76 and one of the rollers 80 are positioned in each of the pockets 72. The springs 76 are oriented within the pockets 72 to bias the rollers 80 in a circumferential direction (i.e. clockwise as viewed in FIG. 2). The springs 76 bias the rollers 80 against the pocket walls 90 and the clutch surface 66. In the illustrated example, the springs 76 are compression springs, however, in other embodiments the springs may be provided as any type of spring or other biasing member, as may he recognized by those of ordinary skill in the art.

As shown in FIG. 3, the clutch collar 62 is provided as part of the ring gear 64. In other embodiments, however, the clutch collar 62 may be separate from the ring gear 64. The outer surface of clutch collar 62 defines the clutch surface 66.

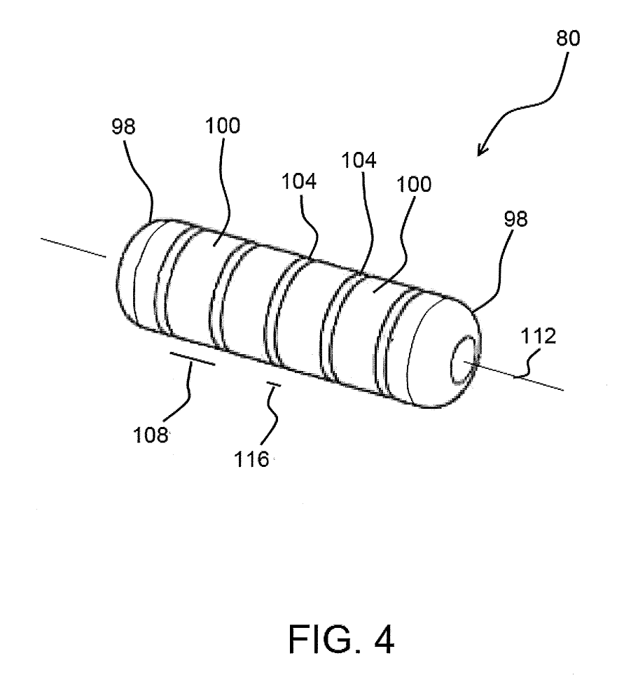

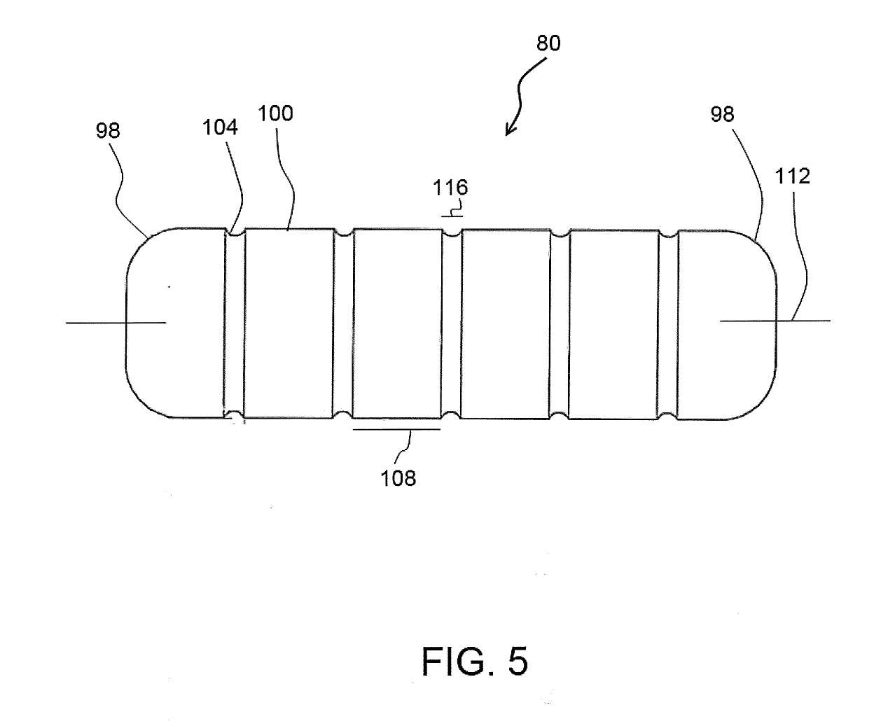

As shown in FIGS. 4 and 5, the rollers 80 of the clutch 26 are generally cylindrical elements. The rollers 80 are at least partially positioned within the shell opening 86 and at least partially positioned within the pockets 72. Therefore, the rollers 80 are positioned between the clutch surface 66 and the shell 68. The ends 98 of the rollers 80 are rounded over to assist in assembling the clutch 26. The rollers 80 are formed form a hard material that resists deformation in response to compressive forces. Accordingly, the rollers 80 may be formed from metal such as steel, aluminum, and the like as well as composite materials, hard plastics, and other materials, as may be recognized by those of ordinary skill in the art.

Each roller 80 defines a plurality of roller surfaces 100 and a plurality of annular grooves 104. The roller surfaces 100 have a length 108, which extends along a longitudinal axis 112 of the roller 80 for a predetermined distance. As shown by the exemplary roller 80, each roller surface 100 has the same length 108; however, in other embodiments the roller surfaces 100 of a particular roller may have different lengths 108. The roller 80 illustrated in the figures is cylindrical; accordingly, the roller surfaces 100 of a particular roller have the same diameter and circumference. In other embodiments, the clutch 26 may include rollers 80 that are generally conical or otherwise non-cylindrical, thereby resulting in the roller surfaces 100 of a particular roller having different diameters and circumferences.

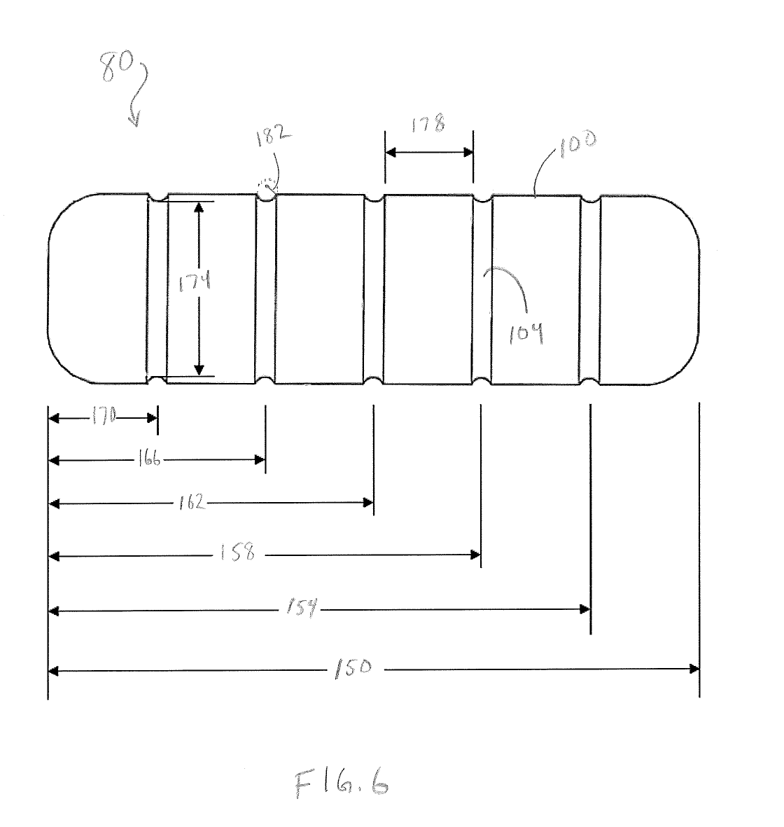

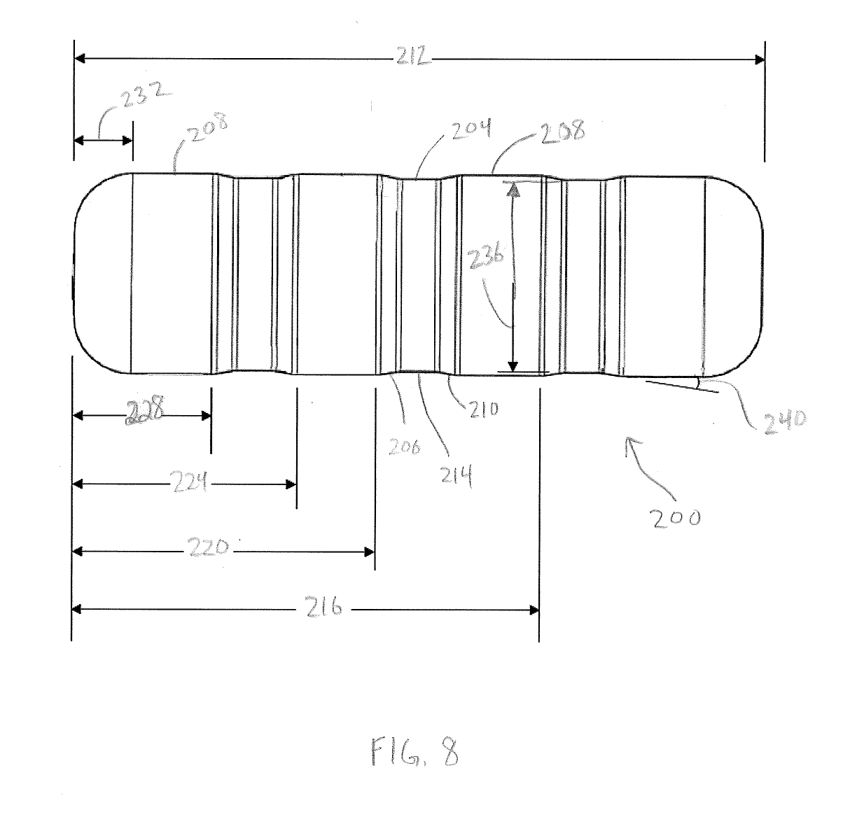

With continued reference to FIGS. 4 and 5, the annular grooves 104 are positioned between the roller surfaces 100 to separate the roller surfaces 100 from each other. The annular grooves 104 have a length 116, which extends for a predetermined distance along the longitudinal axis 112 of the roller 80. In the illustrated embodiment, the grooves 104 each have the same length 116, which is less than the length 108 of the roller surfaces 100. In other embodiments of the roller 80, the grooves 104 of a particular roller may have different lengths 116. The grooves 104 are referred to as being “annular” since they extend completely around the circumference of the roller 80. The grooves 104 are shown as being arcuate in profile (see FIGS. 5 and 6); alternatively, the grooves may have a profile of any of various shapes, as will be recognized by those of ordinary skill in the art (See, e.g., FIG. 8).

As shown in FIG. 6, the exemplary roller 80 may have the following dimensions. The total length 150 of the roller 80 is 23.8 millimeters (“mm”) and may be within the range of 20.0 mm to 28.0 mm. The length 154 is 19.9 mm and may be within the range of 18.0 mm to 22.0 mm. The length 158 is 15.9 mm and may be within the range of 14.0 mm to 18.0 mm. The length 162 is 11.9 mm and may be within the range of 10.0 mm to 14.0 mm. The length 166 is 7.95 mm and may be within the range of 6.0 mm to 10.0 mm. The length 170 is 3.95 mm and may be within the range of 2.0 mm to 6.0 mm. The length 174 is the diameter of the groove 104 and is 6.5 mm and may be within the range of 4.5 mm to 8.5 mm. The length 178 is the width of the roller surface 100 and may be 3.2 mm and may be within the range of 1.2 mm to 5.2 mm. The radius 182 of the groove 104 is 0.4 mm and may be within the range of 0.3 mm to 0.5 mm.

The magnitude of the pressure that the roller surfaces 100 apply to the pocket walls 90 and the clutch surface 66 is determined by the spring constant of the spring 76 and also by the ratio of the lengths 108, 116 of the roller surfaces 100 and the grooves 104. The spring 76 applies a force to the roller 80, which results in the roller being urged against (and in contact with) the pocket wall 90 and the clutch surface 66 with a particular pressure. The roller 80 can be manufactured to apply a particular pressure by “tuning” the length 108 of the contact surfaces. In particular, the pressure applied by the roller 80 is increased by decreasing the length 108 of the roller surfaces 100 and, as a result, increasing the length 116 of the grooves 104. Alternatively, the pressure applied by the roller 80 is decreased by increasing the length 108 of the roller surfaces 100, with the result that the length 116 of the grooves 104 is decreased. Therefore, various pressures can be achieved without modifying the spring 76. Controlling the pressure with which the roller surfaces 100 are urged against the pocket wall 90 and the clutch surface 66 ensures that the spring 76 is able to urge the roller surfaces 100 against the pocket wall and the clutch surface with a pressure that is great enough for the roller surfaces to penetrate the boundary layer of the clutch lubricant (typically oil, grease, or any other suitable lubricant) even at low operating temperatures when the viscosity of the lubricant is at an elevated level. When the roller surfaces 100 penetrate the boundary layer of the lubricant, the roller surfaces 100 contact the pocket walls 90 and the clutch surface 66, and the clutch 26 effectively enters a locked configuration, as described below.

The position of the rollers 80 within the pockets 72 determines if the clutch 26 is in a locked or an unlocked configuration. When the rollers 80 are positioned toward the center of the pockets 72 (not shown in the figures) the rollers 80 are free to rotate and, consequently, the clutch collar 62 and the ring gear 64 are free to rotate relative to the shell 68. This “unlocked” condition occurs when the ring gear 64 is rotated in a counterclockwise direction relative to the shell 68 in the view of FIG. 2. In this instance, friction between the rollers 80 and the clutch surface 66 cause the rollers 80 to move toward the springs 76 and toward the center of the pockets 72 where the annular distance 88 is greatest. The length 108 of the roller surfaces 108 is selected to ensure that the pressure exerted upon the clutch surface 66 and the shell 68 results in a frictional force that causes the rollers 80 to move as described above.

When there is no relative motion between the ring gear 64 and the shell 68, the springs 76 partially wedge the rollers 80 between the clutch surface 66 and the shell 68. With substantially any clockwise rotation of the clutch collar 62 relative to the shell 68, the rollers 80 become even further wedged between the dutch collar and the shell, thereby preventing any additional relative rotation therebetween. In this “locked” configuration, the clutch collar 62 and the ring gear 64 are locked into synchronous movement with the shell 68. The lengths 108 of the roller surfaces 108 are selected to ensure that the pressure exerted upon the clutch surface 66 and the shell 68 causes the roller 80 to become wedged as described above.

In operation, the motor starter 10 is activated to start the engine to which it is connected. When the motor starter 10 is activated, typically by a user closing an ignition switch (not shown), the solenoid 14 is activated and causes the pinion 34 to move into engagement with the flywheel of the engine (not shown). Next, the armature 18 is supplied with electrical energy and begins to rotate.

With reference to FIG. 2, clockwise rotation of the armature 18 is transferred to the sun gear 50. Since the shell 68 is fixed to the housing 12, the rotation of the sun gear 50 causes rotation of the planet gears 54, the flange 60 (FIG. 3), the shaft 30 (FIG. 3), and the pinion 34 (FIG. 3). In particular, the shaft 30 and the pinion 34 are rotated in the same direction as the armature 18, but at a reduced rotational speed due to the reduction action of the gear system 22. The ring gear 64 and the clutch collar 62 are urged in the direction of rotation of the armature 18 (i.e. clockwise); however, the ring gear and clutch collar do not rotate (or rotate for only a few degrees). Instead, as the ring gear 64 is urged in the clockwise direction, the clutch 26 enters the locked configuration, thereby preventing rotation of the ring gear. This causes the rollers 80 to become wedged between the pocket walls 90 and the clutch surface 66 and exert a pressure on the clutch surface and the pocket walls, as described above.

After the engine is started, the engine rotates the flywheel faster than the pinion 34 can drive it; therefore, the flywheel begins to drive the pinion in the clockwise direction. This driving action of the pinion 34 is communicated back to the planet gears 54 through the shaft 30 and the flange 60. When this happens, the clutch 26 disengages the pinion 34 from the armature 18 to prevent damage to the starter motor 10. In particular, the driving action of the flywheel causes the ring gear 64 and the clutch collar 62 to rotate in the counterclockwise direction, which causes the clutch 26 to enter the unlocked configuration. The rotation of the clutch collar 62 in the counterclockwise direction dislodges the rollers 80 from the wedged orientation against the biasing force of the springs 76 and enables the ring gear 64 to rotate freely. Therefore, when the clutch 26 is in the unlocked configuration the armature 18 is not driven by the flywheel of the operating engine. The ring gear 64 is rotated by the flywheel until the pinion 34 is disengaged from the flywheel by removing the supply of electrical energy from solenoid 14.

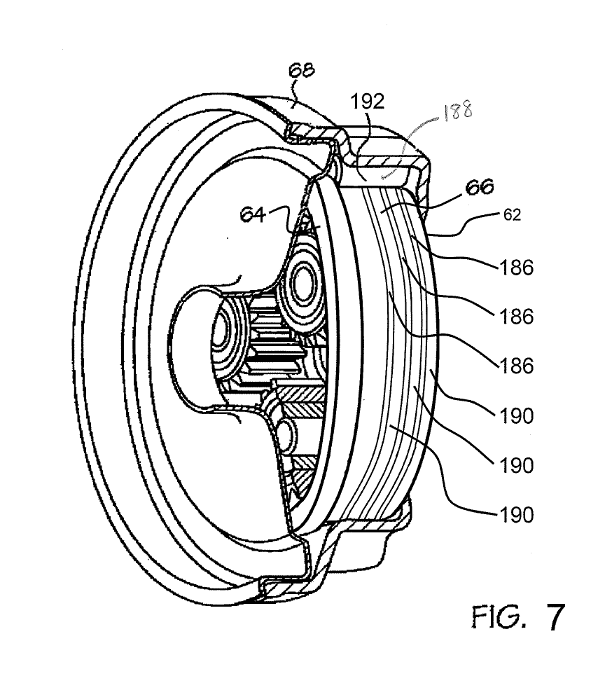

As shown in FIG. 7, in another embodiment of the starter motor 10 the pressure exerted on the clutch surface 66 is controlled by forming grooves 186 on the clutch surface 66 of the clutch collar 64. The grooves 186 are separated by numerous clutch ridges 190, which are configured to contact the roller surface 188 of the roller 192. Accordingly, the pressure exerted on the clutch surface 66 by the roller 192 (which is shown in FIG. 7 without having the grooves 104, but in other embodiments may include the grooves 104) is controllable by adjusting the total width of the clutch ridges 190. This embodiment achieves the same benefits as forming the grooves 104 on the rollers 80; namely, that the pressure exerted on the clutch surface 66 is controllable to enable a pressure to be achieved that is sufficient to penetrate the boundary layer of the clutch lubricant, even at low temperatures when the viscosity of the lubricant is at an elevated level. When the roller surface 188 of each corresponding roller 192 penetrates the boundary layer of the lubricant, the roller surfaces contact the pocket walls 90 and the clutch ridges 190, and the clutch enters the locked configuration.

With reference to FIG. 8, in another embodiment of the starter motor 10 the clutch 26 includes the roller member 200. The roller member 200 functions substantially identically to the roller member 80 except that the grooves 204 have an angled profile. The grooves 204 are defined by a first inclined surface 206, a second inclined surface 210, and a flat surface 214. The roller includes the roller surfaces 208.

The roller 200 shown in FIG. 8, may have the following dimensions. The total length 212 of the roller 80 is 23.8 millimeters (“mm”) and may be within the range of 20.0 mm to 28.0 mm. The length 216 is 16.15 mm and may be within the range of 15.0 mm to 17.0 mm. The length 220 is 10.45 mm and may be within the range of 9.0 mm to 12.0 mm. The length 224 is 2.95 mm and may be within the range of 2.0 mm to 4.0 mm. The length 228 is 4.75 mm and may be within the range of 4.0 mm to 6.0 mm. The length 232 is 2.0 mm and may be within the range of 1.0 mm to 3.0 mm. The length 236 is 6.75 mm and may be within the range of 6.0 mm to 8.0 mm. The angle 240 of the inclined surface 206 and the inclined surface 210 is 10.0 degrees, but may be within the range of 5.0 degrees to 15.0 degrees.

The foregoing detailed description of one or more embodiments of the starter motor 10 has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. A clutch, comprising:
an outer clutch member defining an opening;
an inner clutch member at least partially positioned within the opening and including a clutch surface; and
a plurality of roller members at least partially positioned within the opening between the clutch surface and the outer clutch member, each of the roller members defining a plurality of roller surfaces separated by at least one annular groove, and each of the roller members being displaceable within the opening to position the plurality of roller surfaces into engagement with the clutch surface to lock the inner clutch member into synchronous movement with the outer clutch member in response to movement of the inner clutch member in a rotational direction.

2. The clutch of claim 1, further comprising a plurality of biasing members configured (i) to urge the roller members against the outer clutch member and the clutch surface and (ii) to urge the plurality of roller surfaces against the outer clutch member and the clutch surface.

3. The clutch of claim 2, wherein:
each of the roller members defines a longitudinal axis,
each of the roller surfaces extends for a first predetermined distance along the longitudinal axis, and
each of the annular grooves extends for a second predetermined distance along the longitudinal axis.

4. The clutch of claim 3, wherein the roller surfaces are urged against the outer clutch member and the clutch surface with a pressure based on the first predetermined distance and the second predetermined distance.

5. The clutch of claim 1, wherein:
the roller surfaces are generally cylindrical, and
each of the roller surfaces defines a circumference having a predetermined length.

6. A clutch, comprising:
a shell defining a shell opening and including a plurality of pocket walls, each of the pocket walls defining a pocket in fluid communication with the shell opening;
a clutch collar at least partially positioned within the shell opening and including a clutch surface;
a plurality of roller members each defining a plurality of roller surfaces separated by at least one annular groove, each of the roller members positioned within one of the pockets; and
a plurality of biasing members each (i) positioned within one of the pockets and (ii) configured to urge the roller surfaces of one of the roller members against the clutch surface and one of the pocket walls.

7. The clutch of claim 6, wherein:
each of the roller members defines a longitudinal axis,
each of the roller surfaces extends for a first predetermined distance along the longitudinal axis, and each of the annular grooves extends for a second predetermined distance along the longitudinal axis.

8. The clutch of claim 7, wherein the roller surfaces are urged against the shell and the clutch surface with a pressure based on the first predetermined distance and the second predetermined distance.

9. The clutch of claim 7, wherein:
the roller surfaces are generally cylindrical, and
each of the roller surfaces defines a circumference having a predetermined length.

10. A starter motor for an engine, the starter motor comprising:
an armature;
a solenoid;
a pinion rotatable by the armature and movable by the solenoid into engagement with a corresponding portion of the engine; and
a clutch in operational communication with the pinion and the armature, the clutch including
a shell defining a shell opening,
a clutch collar at least partially positioned within the shell opening and including a clutch surface, and
a plurality of rollers at least partially positioned within the shell opening between the clutch surface and the shell, each of the rollers defining a plurality of roller surfaces separated by at least one annular groove, and each of the rollers being displaceable within the shell opening to position at least a portion of the roller surfaces into engagement with the clutch surface to lock the clutch collar into synchronous movement with the shell in response to movement of the clutch collar in a rotational direction relative to the shell.

11. The starter motor of claim 10, wherein the clutch further comprises a plurality of biasing members configured (i) to urge the roller members against the shell and the clutch surface and (ii) to urge the plurality of roller surfaces against the shell and the clutch surface.

12. The starter motor of claim 11, wherein:
each of the roller members defines a longitudinal axis,
each of the roller surfaces extends for a first predetermined distance along the longitudinal axis, and
each of the annular grooves extends for a second predetermined distance along the longitudinal axis.

13. The starter motor of claim 12, wherein the roller surfaces are urged against the shell and the clutch surface with a pressure based on a ratio of the first predetermined distance and the second predetermined distance.

14. The starter motor of claim 10, wherein:
the roller surfaces are generally cylindrical, and
each of the roller surfaces defines a circumference having a predetermined length.

15. The starter motor of claim 10, wherein the annular grooves have an arcuate profile.

16. The starter motor of claim 10, wherein the rollers are formed from steel.

17. A clutch, comprising:
a shell defining a shell opening and a plurality of pockets in fluid communication with the shell opening;
a clutch collar at least partially positioned within the shell opening and including a clutch surface;
a plurality of roller members each defining a roller surface and each positioned within one of the pockets; and
a plurality of annular grooves formed on at least one of the clutch surface of the clutch collar and the roller surfaces of the roller members.

18. The clutch of claim 17, further comprising:
a plurality of biasing members each (i) positioned within one of the pockets and (ii) configured to urge the roller surfaces of one of the roller members against the clutch surface.

19. The clutch of claim 18, wherein:
a plurality of clutch ridges separate the annular grooves when the annular grooves are formed on the clutch surface, and
a plurality of roller ridges separate the annular grooves when the annular grooves are formed on the roller surfaces.

20. The clutch of claim 19, wherein the roller surfaces are urged against the clutch surface with a pressured based on at least one of (i) a width of the clutch ridges and a width of the annular grooves formed in the clutch surface and (ii) a width of the roller ridges and a width of the annular grooves formed in the roller surface.
